(19) United States
(12) Patent Application Publication
(10) Pub. No.: US 2011/0099007 A1
(43) Pub. Date: Apr. 28, 2011

(54) NOISE ESTIMATION USING AN ADAPTIVE SMOOTHING FACTOR BASED ON A TEAGER ENERGY RATIO IN A MULTI-CHANNEL NOISE SUPPRESSION SYSTEM

(75) Inventor: Xianxian Zhang, San Diego, CA (US)

(73) Assignee: BROADCOM CORPORATION, Irvine, CA (US)

(21) Appl. No.: 12/706,890

(22) Filed: Feb. 17, 2010

Related U.S. Application Data
(60) Provisional application No. 61/254,032, filed on Oct. 22, 2009.

(51) Int. Cl. G10L 21/00; G10L 21/02

(52) U.S. Cl. 704/211; 704/226; 704/E21.002

(57) ABSTRACT

Techniques are described herein that provide multi-channel noise suppression based on a Teager energy ratio. A Teager energy ratio is a ratio of an average Teager energy operator (TEO) energy of a first signal to an average TEO energy of a second signal. The average TEO energy of a signal is defined by the equation:

$${\overline{E}}_{signal} = \frac{1}{N} {\sum }_{i = 1}^{N} [ {x}^{2} ( n ) - x ( n + 1 ) x ( n - 1 ) ] .$$

In this equation, Ē_{signal} represents the average TEO energy of the signal; N represents the number of frames in the signal; x(n) represents a magnitude of the signal with respect to an nth frame; x(n+1) represents a magnitude of the signal with respect to an (n+1)th frame; and x(n−1) represents a magnitude of the signal with respect to an (n−1)th frame.

### CROSS-REFERENCE TO RELATED APPLICATIONS

This application claims the benefit of U.S. Provisional Application No. 61/254,032, filed Oct. 22, 2009, the entirety of which is incorporated by reference herein.

### BACKGROUND OF THE INVENTION

1. Field of the Invention

The invention generally relates to noise suppression.

2. Background

Modern communication devices often include a primary sensor (e.g., a primary microphone) for detecting speech of a user and a reference sensor (e.g., a reference microphone) for detecting noise that may interfere with accuracy of the detected speech. A signal that is received by the primary sensor is referred to as a primary signal. In practice, the primary signal usually includes a speech component (e.g., a user's speech) and a noise component (e.g., background noise). A signal that is received by the reference sensor is referred to as a reference signal. The reference signal usually includes reference noise (e.g., background noise), which may be combined with the primary signal to provide a speech signal that has a reduced noise component, as compared to the primary signal.

For example, a communication device may include a dual-channel adaptive noise canceller that is configured to approximate a transfer function between a primary sensor and a reference sensor. In accordance with this example, the noise canceller may filter a reference signal and subtract reference noise that is included in the reference signal from a primary signal to provide a speech signal. The speech signal is intended to be an accurate representation of a speech component that is included in the primary signal.

However, the speech signal often includes residual noise. Many techniques for decreasing the residual noise of the speech signal involve estimating the noise power spectrum of the speech signal. These techniques traditionally average the speech signal over non-speech portions thereof (i.e., portions of the speech signal in which speech is not present). For instance, a voice activity detector (VAD) is usually used to indicate which portions of the speech signal do not include speech. However, detection reliability of a VAD may decrease substantially for low input signal-to-noise ratios (SNRs) and/or for speech signals having relatively weak speech components. Moreover, the number of presumable non-speech portions of the speech signal may not be sufficient for a noise estimator to accurately estimate the noise power spectrum of the speech signal. For instance, an insufficient number of non-speech portions may limit the ability of the noise estimator to track a varying noise power spectrum.

### BRIEF SUMMARY OF THE INVENTION

A system and/or method for providing noise estimation using an adaptive smoothing factor based on a Teager energy ratio in a multi-channel noise suppression system, substantially as shown in and/or described in connection with at least one of the figures, as set forth more completely in the claims.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 depicts a front view of an example wireless communication device in accordance with an embodiment described herein.

FIG. 2 depicts a back view of an example wireless communication device shown in FIG. 1 in accordance with an embodiment described herein.

FIG. 3 is a block diagram of an example multi-channel noise suppression system in accordance with an embodiment described herein.

FIGS. 4, 5, 7, 11, and 13 depict flowcharts of example methods for suppressing noise in accordance with embodiments described herein.

FIG. 6 is a block diagram of an example implementation of a first constraint module shown in FIG. 3 in accordance with an embodiment described herein.

FIG. 8 is a block diagram of an example implementation of a second constraint module shown in FIG. 3 in accordance with an embodiment described herein.

FIG. 9 depicts an example technique to determine a maximum correlation between a primary signal P(n) and instances of a reference signal R(n) in accordance with an embodiment described herein.

FIG. 10 is a block diagram of an example multi-channel post processor in accordance with an embodiment described herein.

FIG. 12 depicts a graphical representation of an example relationship between a smoothing factor and a ratio of a speech signal to a noise signal in accordance with an embodiment described herein.

FIG. 14 is a block diagram of an example implementation of a single-channel noise suppressor shown in FIG. 10 in accordance with an embodiment described herein.

FIG. 15 depicts a graphical representation of an example primary signal that is unfiltered.

FIG. 16 depicts a graphical representation of an example primary signal shown in FIG. 15 that has been filtered using a conventional noise suppression technique.

FIG. 17 depicts a graphical representation of an example primary signal shown in FIG. 15 that has been filtered using a noise suppression technique in accordance with an embodiment described herein.

FIG. 18 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate example embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Various approaches are described herein for, among other things, providing noise estimation using an adaptive smoothing factor based on a Teager energy ratio in a multi-channel noise suppression system. A Teager energy ratio is a ratio of an average Teager energy operator (TEO) energy of a first signal to an average TEO energy of a second signal.

The average TEO energy of a signal is defined by the equation:

$${\overline{E}}_{signal} = \frac{1}{N} {\sum }_{i = 1}^{N} [ {x}^{2} ( n ) - x ( n + 1 ) x ( n - 1 ) ] . \qquad ( Equation 1 )$$

In Equation 1, Ē_{signal} represents the average TEO energy of the signal x(n), and N represents the number of samples (a.k.a. frames) of the signal x(n). N may be any positive integer (e.g., 3, 10, 51, 80, 152, etc.).

In accordance with the noise suppression techniques described herein, the average TEO energies of the respective first and second signals are calculated using Equation 1. The average TEO energy of the first signal is divided by the average TEO energy of the second signal to provide a ratio of the average TEO energy of the first signal to the average TEO energy of the second signal.

In accordance with some example embodiments, the first signal is a primary signal that is received at a primary sensor (e.g., a primary microphone), and the second signal is a reference signal that is received at a reference sensor (e.g., a reference microphone). For instance, these embodiments may process the primary signal based on the ratio of the average TEO energy of the primary signal to the average TEO energy of the reference signal to provide a speech signal that includes less noise than the primary signal.

In accordance with other example embodiments, the first signal is a speech signal, and the second signal is a noise signal. For instance, these embodiments may process the speech signal based on the ratio of the average TEO energy of the speech signal to the average TEO energy of the noise signal to provide an output signal that includes less noise than the speech signal.

An example system is described that includes a first constraint module, a second constraint module, an adaptive speech filter, and an adaptive noise filter. The first constraint module is configured to determine a value of a first speech indicator to indicate whether a primary signal includes speech according to a first determination technique. The second constraint module is configured to determine a value of a second speech indicator to indicate whether the primary signal includes speech according to a second determination technique that is different from the first determination technique. At least one of the first constraint module or the second constraint module is configured to utilize a ratio of an average TEO energy of the primary signal to an average TEO energy of a reference signal to determine a respective at least one of the first speech indicator or the second speech indicator. The adaptive speech filter is configured to filter the primary signal based on the first speech indicator and a noise signal to provide a speech signal. The adaptive noise filter is configured to filter the reference signal based on the second speech indicator and the speech signal to provide the noise signal.

Another example system is described that includes an energy calculator, a factor calculator, and a single-channel noise suppressor. The energy calculator is configured to calculate an average TEO energy of a speech signal and an average TEO energy of a noise signal. The energy calculator is further configured to calculate a ratio of the average TEO energy of the speech signal to the average TEO energy of the noise signal. The factor calculator is configured to calculate an adaptive smoothing factor that is based on the ratio. The single-channel noise suppressor is configured to estimate a noise power spectrum of the speech signal based on the smoothing factor.

Yet another example system is described that includes the first and second example systems. For instance, an output of the first example system may be coupled to an input of the second example system, such that the second example system estimates the noise power spectrum of the speech signal that is provided by the first example system.

An example method is described for suppressing noise. In accordance with this example method, a value of a first speech indicator is determined to indicate whether a primary signal includes speech using a first determination technique. A value of a second speech indicator is determined to indicate whether the primary signal includes speech using a second determination technique. The second determination technique is different from the first determination technique. At least one of the first determination technique or the second determination technique utilizes a ratio of an average TEO operator energy of the primary signal to an average TEO energy of a reference signal. The primary signal is filtered using an asymmetric crosstalk resistant adaptive noise canceller (ACTRANC) based on the first speech indicator and a noise signal to provide a speech signal. The reference signal is filtered using the ACTRANC based on the second speech indicator and the speech signal to provide the noise signal.

Another example method is described for suppressing noise. In accordance with this example method, an average TEO energy of a speech signal is calculated. An average TEO energy of a noise signal is calculated. A ratio of the average TEO energy of the speech signal to the average TEO energy of the noise signal is calculated. An adaptive smoothing factor is determined that is based on the ratio. A noise power spectrum of the speech signal is estimated based on the smoothing factor.

The noise suppression techniques described herein have a variety of benefits as compared to conventional noise suppression techniques. For instance, the techniques described herein may reduce distortion of a primary or speech signal and/or suppress noise (e.g., background noise, babble noise, etc.) that is associated with the primary or speech signal more than conventional techniques. The use of multiple constraint modules having different decision rules may increase the accuracy of determinations regarding whether a primary signal and/or a reference signal includes speech. For instance, the constraint modules may provide more accurate determinations than voice activity detectors (VADs) that are often included in conventional noise suppression systems.

Using an adaptive smoothing factor that is based on a Teager energy ratio to estimate noise may allow for continuous updating of the noise power spectrum frame-by-frame (e.g., regardless whether the frames include speech), rather than updating only during speech-inactive periods as is common with VADs. Speech-inactive periods are periods during which speech does not occur. Accordingly, using such an adaptive smoothing factor may avoid errors that are commonly introduced by VADs because the changes of the noise may continue to be tracked during active speech periods. Comparing speech and noise signals at an output of an ACTRANC, for example, rather than using a VAD or comparing primary and reference signals at an input of the ACTRANC, to determine the smoothing factor may provide more accurate detection of speech in situations that are characterized by weak speech, low input signal-to-noise ratios (SNRs), and/or substantial speech leakage to the reference sensor. Moreover, using TEO energy may enhance the discriminability between speech and noise signals.

### II. Example Noise Suppression Embodiments

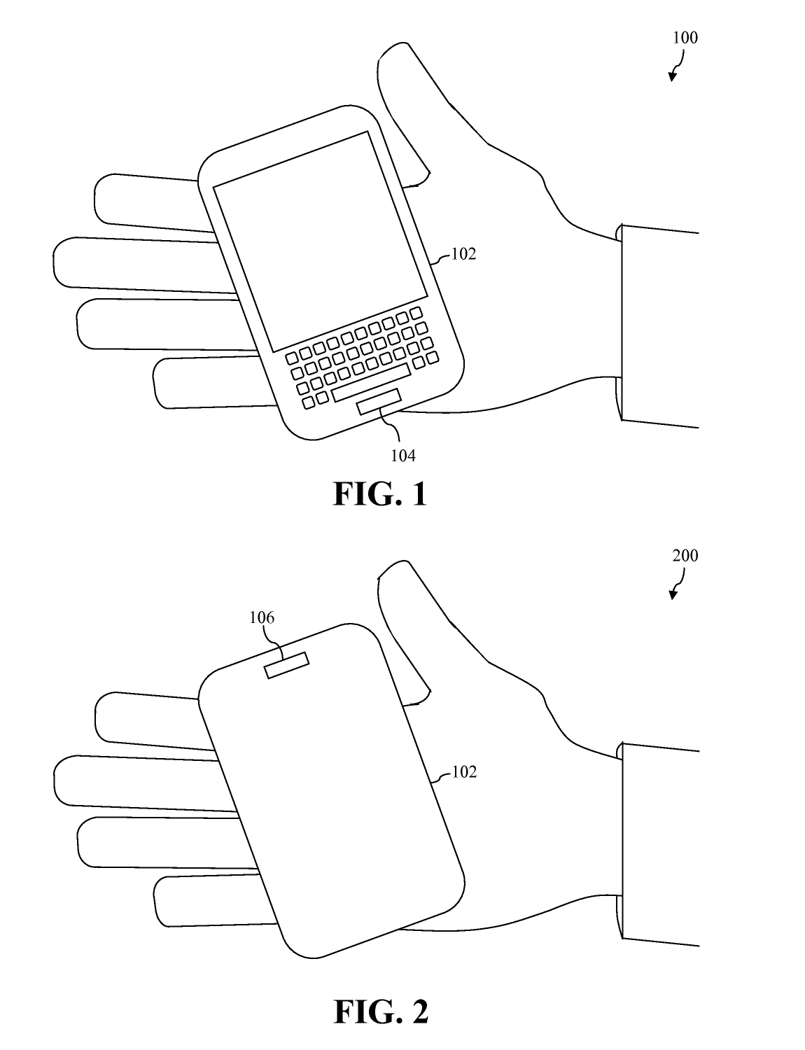

FIGS. 1 and 2 depict respective front and back views of an example wireless communication device 102 in accordance with embodiments described herein. For example, wireless communication device 102 may be a personal digital assistant, (PDA), a cellular telephone, a tablet computer, etc. As shown in FIG. 1, a front portion of wireless communication device 102 includes a primary sensor 104 (e.g., a primary microphone) that is positioned to be proximate a user's mouth during regular use of wireless communication device 102. Accordingly, primary sensor 104 is positioned to detect the user's speech. As shown in FIG. 2, a back portion of wireless communication device 102 includes a reference sensor (e.g., a reference microphone) that is positioned to be farther from the user's mouth during regular use than primary sensor 104. For instance, reference sensor 106 may be positioned as far from the user's mount during regular use as possible.

By positioning primary sensor 104 so that it is closer to the user's mouth than reference sensor 106 during regular use, a magnitude of the user's speech that is detected by primary sensor 104 is likely to be greater than a magnitude of the user's speech that is detected by reference sensor 106. Furthermore, a magnitude of background noise that is detected by primary sensor 104 is likely to be less than a magnitude of the background noise that is detected by reference sensor 106. Example techniques for suppressing noise with respect to a user's speech are described in greater detail in the following discussion.

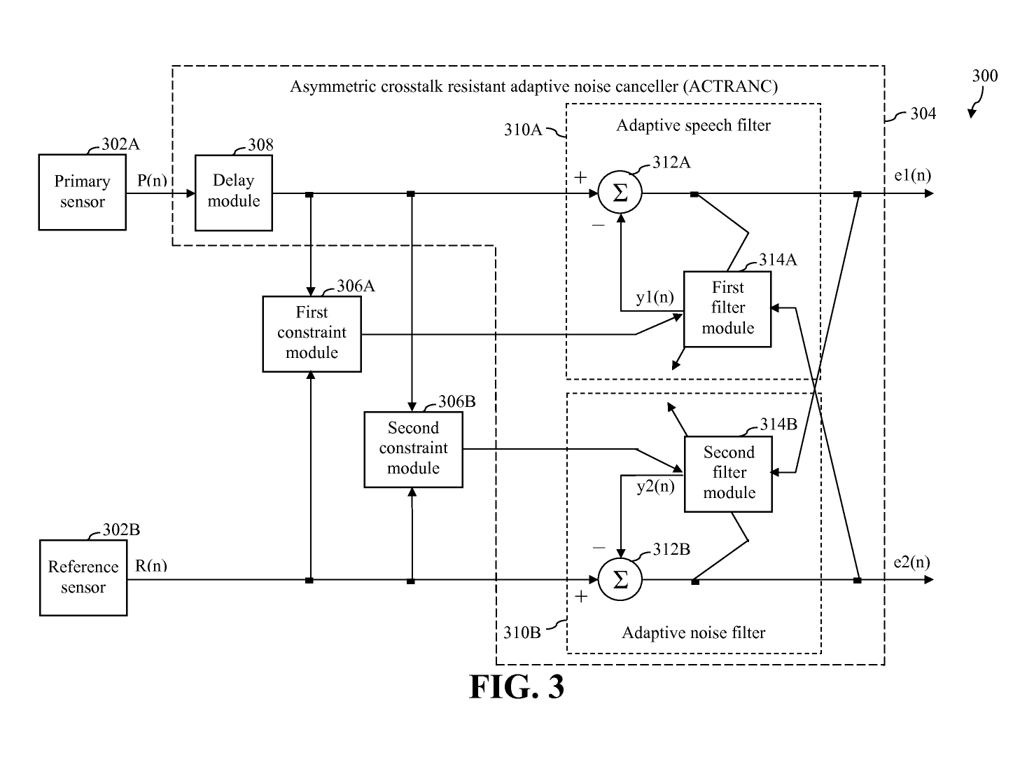

Primary sensor 104 and reference sensor 106 are shown to be positioned on the respective front and back portions of wireless communication device 102 in respective FIGS. 2 and 3 for illustrative purposes and are not intended to be limiting. Persons skilled in the relevant art(s) will recognize that primary sensor 104 and reference sensor 106 may be positioned in any suitable locations on wireless communication device 102. Nevertheless, the effectiveness of the techniques described herein may be improved if primary sensor 104 and reference sensor 106 are positioned on communication device 102 such that primary sensor 104 is closer to the user's mouth during regular use of wireless communication device 102 than reference sensor 106.

One reference sensor 106 is shown in FIG. 2 for illustrative purposes and is not intended to be limiting. It will be recognized that wireless communication device 102 may include any number of reference sensors. Moreover, primary sensor 104 and reference sensor 106 are shown in respective FIGS. 1 and 2 to be included in wireless communication device 102 for illustrative purposes, though it will be recognized that primary sensor 104 and reference sensor 106 may be included in any suitable device (e.g., a non-wireless communication device, a Bluetooth® headset, a hearing aid, a personal recorder (e.g., a dictation device), etc.).

FIG. 3 is a block diagram of an example multi-channel noise suppression system 300 in accordance with an embodiment described herein. Generally speaking, multi-channel noise suppression system 300 operates to suppress noise that is associated with a primary signal P(n) based on a reference signal R(n) to provide a speech signal e1(n). Further detail regarding techniques for suppressing noise that is associated with a primary signal is provided in the following discussion.

As shown in FIG. 3, multi-channel noise suppression system 300 includes a primary sensor 302A (e.g., a primary microphone), a reference sensor 302B (e.g., a reference microphone), a first constraint module 304A, a second constraint module 304B, and an asymmetric crosstalk resistant adaptive noise canceller (ACTRANC) 304. Primary sensor 302A is configured to receive a primary signal P(n). The primary signal P(n) includes a speech component (e.g., a user's speech) and a noise component (e.g., background noise). Reference sensor 302B is configured to receive a reference signal R(n). The reference signal R(n) includes reference noise (e.g., background noise).

ACTRANC 304 is configured to process the primary signal P(n) and the reference signal R(n) to provide the speech signal e1(n) and a noise signal e2(n). ACTRANC 304 includes a delay module 308, an adaptive speech filter 310A, and an adaptive noise filter 310B. Delay module 308 is configured to delay the primary signal P(n) with respect to the reference signal R(n). For example, leakage of the speech component of the primary signal P(n) onto the reference signal R(n) may not occur instantaneously. In accordance with this example, leakage of the speech component of the primary signal P(n) onto the reference signal R(n) may be delayed by a time period that corresponds to a difference between a duration of time it takes for the primary signal P(n) to travel from a user's mouth to primary sensor 302A and a duration of time it takes for the primary signal P(n) to travel from the user's mouth to reference sensor 302B.

Adaptive speech filter 310A is configured to filter the primary signal P(n) based on the noise signal e2(n) and a first speech indicator that is received from first constraint module 306A to provide the speech signal e1(n). Accordingly, adaptive speech filter 310A adaptively removes noise from the speech signal e1(n). Adaptive speech filter 310A includes a combiner 312A and a first filter module 314A. Combiner 312A subtracts a first intermediate signal y1(n) from the primary signal P(n) to provide the speech signal e1(n). First filter module 314A manipulates the noise signal e2(n) based on the speech signal e1(n) and the first speech indicator to provide the first intermediate signal y1(n).

First filter module 314A may be configured to determine whether to update coefficient(s) of a transfer function of first filter module 314A based on a value of the first speech indicator. For example, if the first speech indicator has a first value, first filter module 314A updates the coefficient(s) of its transfer function. In accordance with this example, if the first speech indicator has a second value, first filter module 314A does not update the coefficient(s) of its transfer function. For instance, the first value may indicate that the primary signal P(n) does not include speech, and the second value may indicate that the primary signal P(n) includes speech. In accordance with an example embodiment, first filter module 314A updates the coefficient(s) of its transfer function if and only if the value of the first speech indicator indicates that the primary signal P(n) does not include speech.

A volume change or a change of the user's distance from primary sensor 302A may affect whether the coefficient(s) of the transfer function are updated. For instance, if the volume of the user's speech decreases or the distance of the user's mouth to primary sensor 302A increases, filter module 314A may increase the coefficient(s) of the transfer function.

Adaptive noise filter 310B is configured to filter the reference signal R(n) based on the speech signal e1(n) and a second speech indicator that is received from second constraint module 306B to provide the noise signal e2(n). Accordingly, adaptive noise filter 310B adaptively removes speech from the noise signal e2(n). Adaptive noise filter 310B includes a combiner 312B and a second filter module 314B. Combiner 312B subtracts a second intermediate signal y2(n) from the reference signal R(n) to provide the noise signal e2(n). Second filter module 314B manipulates the speech signal e1(n) based on the noise signal e2(n) and the second speech indicator to provide the second intermediate signal y2(n). For instance, second filter module 314B may be configured to reduce and/or eliminate crosstalk with respect to the primary signal.

Second filter module 314B may be configured to determine whether to update coefficient(s) of a transfer function of second filter module 314B based on a value of the second speech indicator. For example, if the second speech indicator has a third value, second filter module 314B updates the coefficient(s) of its transfer function. In accordance with this example, if the second speech indicator has a fourth value, second filter module 314B does not update the coefficient(s) of its transfer function. For instance, the third value may indicate that the primary signal P(n) includes speech, and the fourth value may indicate that the primary signal P(n) does not include speech. In accordance with an example embodiment, second filter module 314B updates the coefficient(s) of its transfer function if and only if the value of the second speech indicator indicates that the primary signal P(n) includes speech.

First filter module 314A and second filter module 314B may be configured to update coefficients of their transfer functions using any suitable technique, including but not limited to a normalized least mean square technique, a recursive least square technique, an adaptive filtering technique that utilizes an adaptive step size, etc. For instance, using an adaptive step size may increase the rate of convergence for updating the coefficients. In an example embodiment, a normalized least mean square technique is used with a filter length of sixty-four samples and step sizes of 0.009 and 0.01 for the respective first and second filter modules 314A and 314B, though the example embodiments are not limited in this respect.

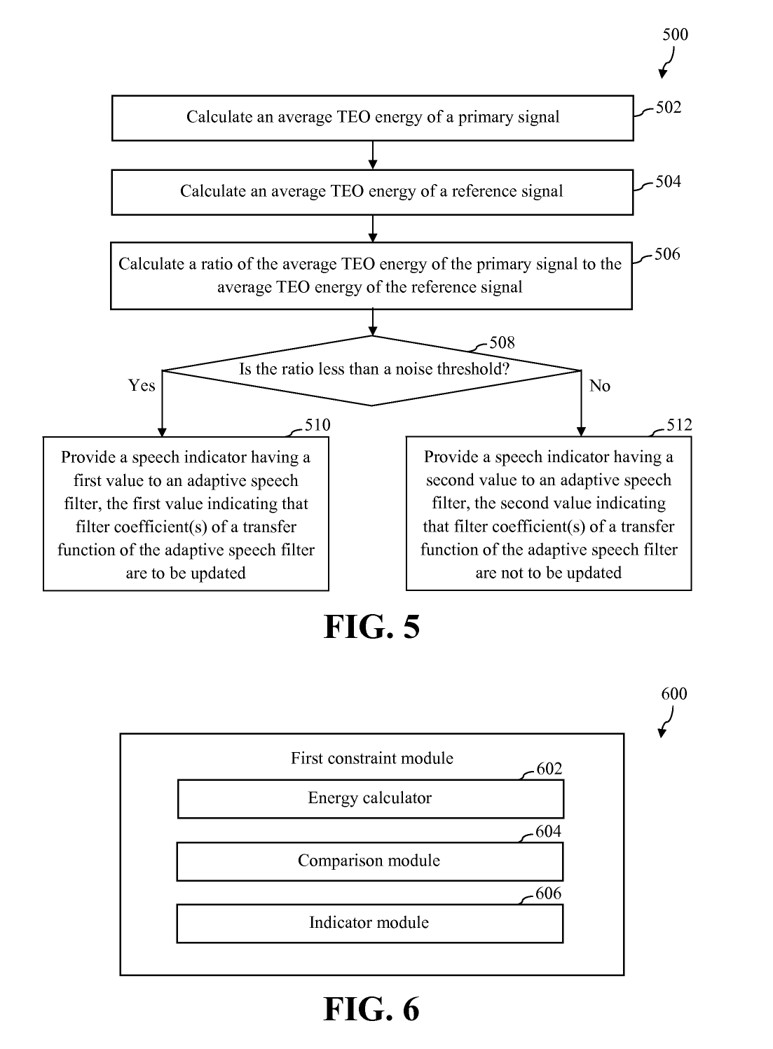

First constraint module 306A is configured to process the primary signal P(n) and the reference signal R(n) in accordance with a first technique to determine whether the primary signal P(n) includes speech. Upon making the determination, first constraint module 306A provides the first speech indicator to first filter module 314A for processing as described above. The value of the first speech indicator indicates whether the primary signal P(n) includes speech, as determined in accordance with the first technique. Further detail regarding example functionality and structure of first constraint module 306A is described below with reference to respective FIGS. 5 and 6.

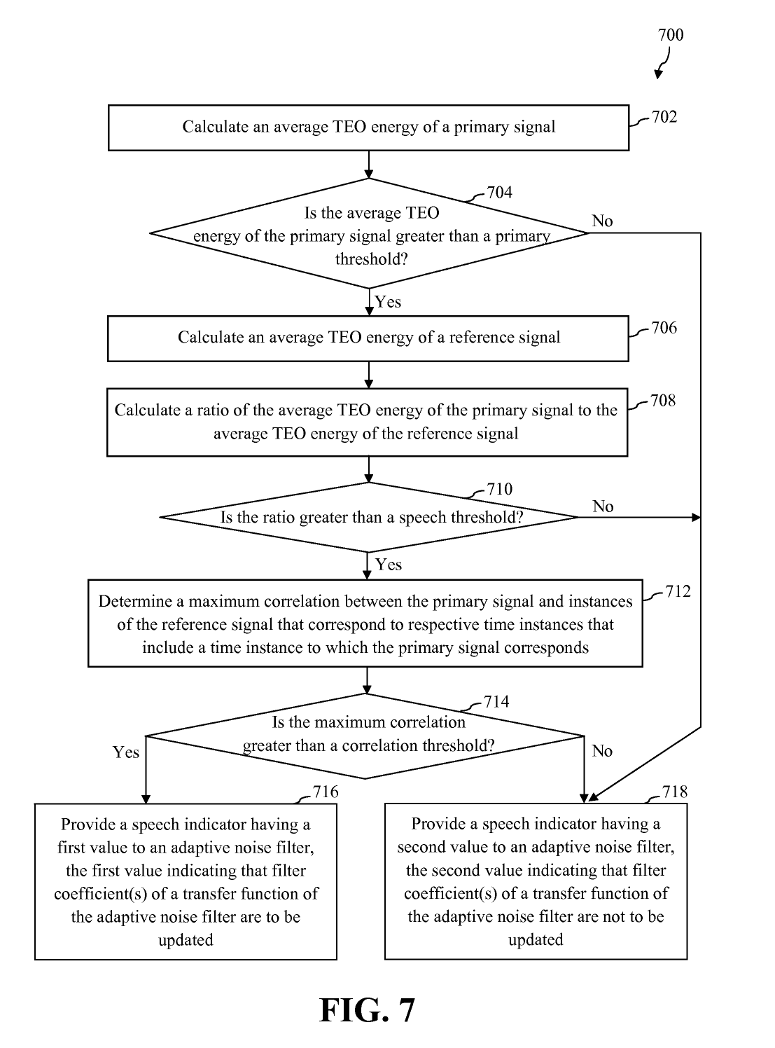

Second constraint module 306B is configured to process the primary signal P(n) and potentially the reference signal R(n) in accordance with a second technique to determine whether the primary signal P(n) includes speech. Upon making the determination, second constraint module 306B provides a second speech indicator to second filter module 314B for processing as described above. The value of the second speech indicator indicates whether the primary signal P(n) includes speech, as determined in accordance with the second technique. Further detail regarding example functionality and structure of second constraint module 306B is described below with reference to FIGS. 7-9.

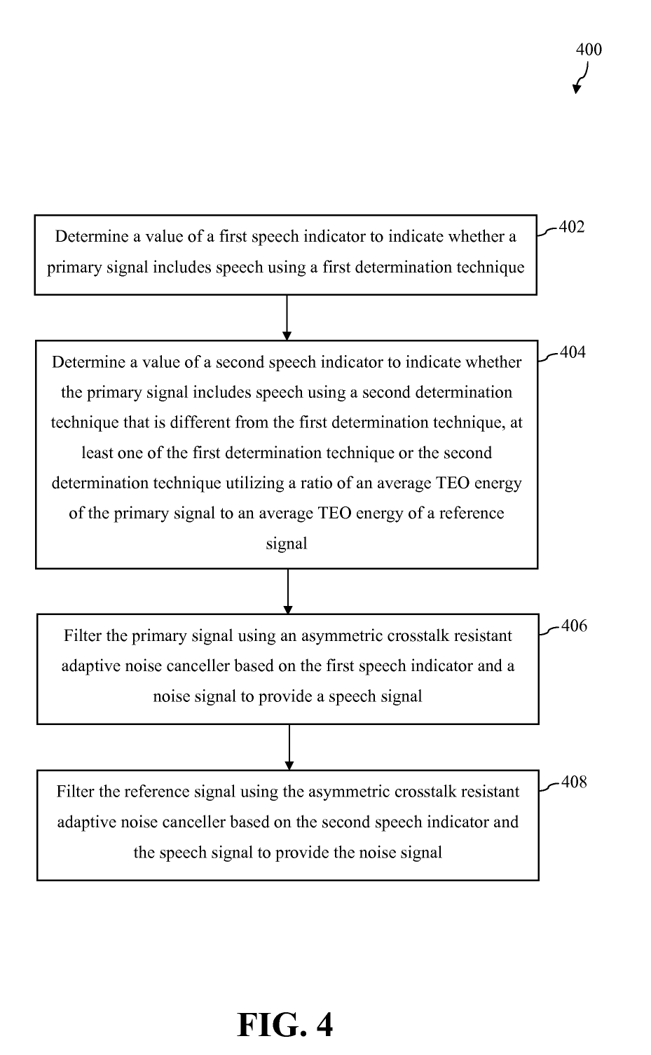

FIG. 4 depicts a flowchart 400 of an example method for suppressing noise in accordance with an embodiment described herein. The method of flowchart 400 will now be described in reference to certain elements of example multi-channel noise suppression system 300 as described above in reference to FIG. 3. However, the method is not limited to that implementation.

As shown in FIG. 4, flowchart 400 starts at step 402. In step 402, a value of a first speech indicator is determined to indicate whether a primary signal includes speech using a first determination technique. In an example implementation, first constraint module 306A determines the value of the first speech indicator to determine whether primary signal P(n) includes speech using the first determination technique.

At step 404, a value of a second speech indicator is determined to indicate whether the primary signal includes speech using a second determination technique that is different from the first determination technique. At least one of the first determination technique or the second determination technique utilizes a ratio of an average Teager energy operator (TEO) energy of the primary signal to an average TEO energy of a reference signal. In an example implementation, second constraint module 306A determines the value of the second speech indicator to determine whether the primary signal P(n) includes speech using the second determination technique.

At step 406, the primary signal is filtered using an asymmetric crosstalk resistant adaptive noise canceller based on the first speech indicator and a noise signal to provide a speech signal. In an example implementation, ACTRANC 304 filters the primary signal. For instance, adaptive speech filter 310A may filter the primary signal P(n) based on the first speech indicator and noise signal e2(n) to provide speech signal e1(n).

At step 408, the reference signal is filtered using the asymmetric crosstalk resistant adaptive noise canceller based on the second speech indicator and the speech signal to provide the noise signal. In an example implementation, ACTRANC 304 filters the reference signal. For instance, adaptive noise filter 310B may filter reference signal R(n) based on the second speech indicator and the speech signal e1(n) to provide the noise signal e2(n).

FIG. 5 depicts a flowchart 500 of another example method for suppressing noise in accordance with an embodiment described herein. Flowchart 500 may be performed by first constraint module 306A of multi-channel noise suppression system 300 shown in FIG. 3, for example. For illustrative purposes, flowchart 500 is described with respect to a first constraint module 600 shown in FIG. 6, which is an example of a first constraint module 306A, according to an embodiment. As shown in FIG. 6, first constraint module 600 includes an energy calculator 602, a comparison module 604, and an indicator module 606. Further structural and operational embodiments will be apparent to persons skilled in the relevant art(s) based on the discussion regarding flowchart 500.

As shown in FIG. 5, the method of flowchart 500 begins at step 502. In step 502, an average Teager energy operator (TEO) energy of a primary signal is calculated. For example, using Equation 1, the average TEO energy of the primary signal may be represented by the equation:

$${\overline{E}}_{primary} = \frac{1}{N} {\sum }_{i = 1}^{N} [ {P}^{2} ( n ) - P ( n + 1 ) P ( n - 1 ) ] , \qquad ( Equation 2 )$$

where P(n) represents the primary signal, and N represents the number of samples of the primary signal P(n). In an example implementation, energy calculator 602 calculates the average TEO energy of the primary signal.

At step 504, an average TEO energy of a reference signal is calculated. For example, using Equation 1, the average TEO energy of the reference signal may be represented by the equation:

$${\overline{E}}_{reference} = \frac{1}{N} {\sum }_{i = 1}^{N} [ {R}^{2} ( n ) - R ( n + 1 ) R ( n - 1 ) ] , \qquad ( Equation 3 )$$

where R(n) represents the reference signal, and N represents the number of samples of the reference signal R(n). In an example implementation, energy calculator 602 calculates the average TEO energy of the reference signal.

At step 506, a ratio of the average TEO energy of the primary signal to the average TEO energy of the reference signal is calculated. For example, the ratio of the average TEO energy of the primary signal to the average TEO energy of the reference signal may be represented by the equation:

$${R}_{TEO} = \frac{{\overline{E}}_{primary}}{{\overline{E}}_{reference}} , \qquad ( Equation 4 )$$

In an example implementation, energy calculator 602 calculates the ratio of the average TEO energy of the primary signal to the average TEO energy of the reference signal.

At step 508, a determination is made whether the ratio is less than a noise threshold. A noise threshold is a representative magnitude below which speech is considered to be absent from a signal. For example, the ratio being less than the noise threshold may indicate that the primary signal does not include speech. In accordance with this example, the ratio being greater than the noise threshold may indicate that the primary signal includes speech. In an example implementation, comparison module 604 determines whether the ratio is less than the noise threshold. If the ratio is less than the noise threshold, flow continues to step 510. Otherwise, flow continues to step 512.

At step 510, a speech indicator having a first value is provided to an adaptive speech filter. The first value indicates that filter coefficient(s) of a transfer function of the adaptive speech filter are to be updated. In an example implementation, indicator module 606 provides the speech indicator to the adaptive speech filter. For instance, indicator module 606 may determine that the speech indicator is to have the first value in response to the primary signal not including speech.

At step 512, a speech indicator having a second value is provided to an adaptive speech filter. The second value indicates that filter coefficient(s) of a transfer function of the adaptive speech filter are not to be updated. The second value is different from the first value. In an example implementation, indicator module 606 provides the speech indicator to the adaptive speech filter. For instance, indicator module 606 may determine that the speech indicator is to have the second value in response to the primary signal including speech.

In an example embodiment, first constraint module 600 is configured to compare the ratio to a leakage threshold. The leakage threshold denotes the amount of the speech component of the primary signal that leaks onto the reference signal. In accordance with this example embodiment, first constraint module 600 is further configured to update the noise threshold to take into consideration a first proportion of the ratio if the ratio is less than a leakage threshold and to take into consideration a second proportion of the ratio if the ratio is greater than the leakage threshold. The second proportion is different from the first proportion.

For example, the noise threshold may be updated in accordance with Equations 5 and 6 below if the ratio is less than the leakage threshold.

Ēₙ_{_{—}}ₜₕᵣₑₛₕ^{new}=α×(Ēₙ_{_{—}}ₜₕᵣₑₛₕ^{old})+(1−α)×R_{TEO} (Equation 5)

Ēₙ_{_{—}}ₜₕᵣₑₛₕ=ρ×Ēₙ_{_{—}}ₜₕᵣₑₛₕ^{new} (Equation 6)

where Ēₙ_{_{—}}ₜₕᵣₑₛₕ represents the noise threshold, 0<α<1, and 0<ρ<1. In accordance with one example implementation, α=0.6 and ρ=1.125, though the scope of the example embodiments is not limited in this respect.

In accordance with this example, the noise threshold may be updated in accordance with Equations 7 and 8 below if the ratio is greater than the leakage threshold.

Ēₙ_{_{—}}ₜₕᵣₑₛₕ^{new}=β×(Ēₙ_{_{—}}ₜₕᵣₑₛₕ^{old})+(1−β)×R_{TEO} (Equation 7)

Ēₙ_{_{—}}ₜₕᵣₑₛₕ=ρ×Ēₙ_{_{—}}ₜₕᵣₑₛₕ^{new} (Equation 8)

where 0<β<1. In accordance with one example implementation, (β=0.999, though the scope of the example embodiments is not limited in this respect.

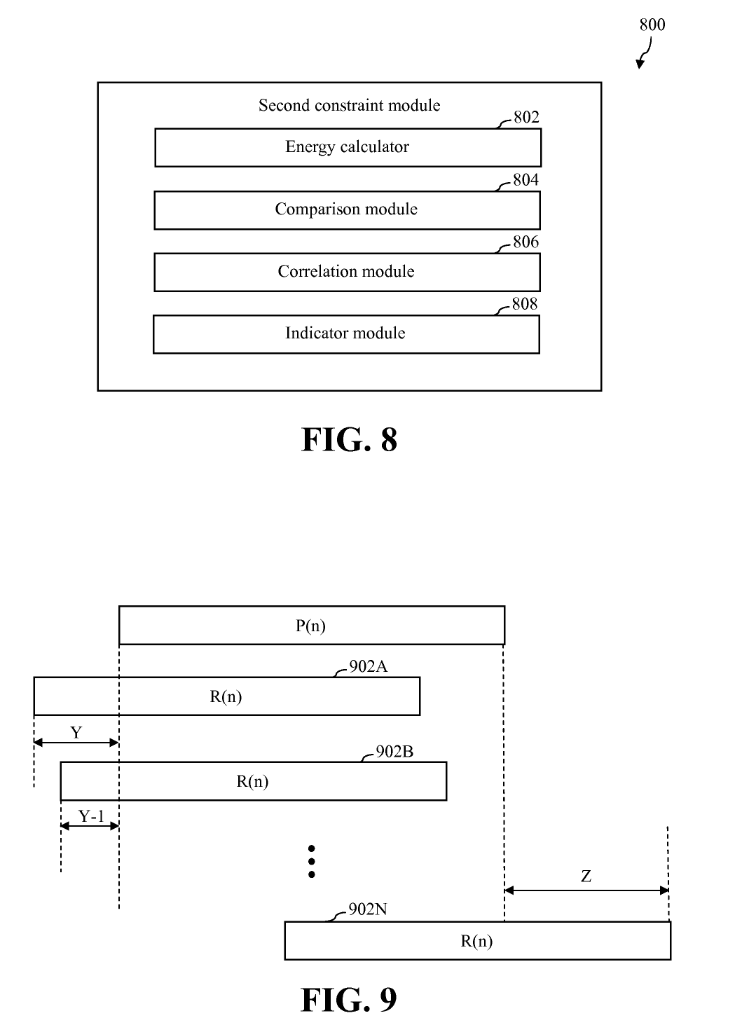

FIG. 7 depicts a flowchart 700 of yet another example method for suppressing noise in accordance with an embodiment described herein. Flowchart 700 may be performed by second constraint module 306B of multi-channel noise suppression system 300 shown in FIG. 3, for example. For illustrative purposes, flowchart 700 is described with respect to a second constraint module 800 shown in FIG. 8, which is an example of a second constraint module 306B, according to an embodiment. As shown in FIG. 8, second constraint module 800 includes an energy calculator 802, a comparison module 804, a correlation module 806, and an indicator module 808. Further structural and operational embodiments will be apparent to persons skilled in the relevant art(s) based on the discussion regarding flowchart 700.

As shown in FIG. 7, the method of flowchart 700 begins at step 702. In step 702, an average Teager energy operator (TEO) energy of a primary signal is calculated. In an example implementation, energy calculator 802 calculates the average TEO energy of the primary signal.

At step 704, a determination is made whether the average TEO energy of the primary signal is greater than a primary threshold. For example, the average TEO energy of the primary signal being greater than the primary threshold may indicate that the primary signal includes speech. In accordance with this example, the average TEO energy of the primary signal being less than the primary threshold may indicate that the primary signal does not include speech. In an example implementation, comparison module 804 determines whether the average TEO energy of the primary signal is greater than the primary threshold. If the average TEO energy of the primary signal is greater than the primary threshold, flow continues to step 706. Otherwise, flow continues to step 718.

In an example embodiment, second constraint module 800 is configured to update the primary threshold to take into consideration the average TEO energy of the primary signal. For example, the primary threshold may be updated in accordance with Equation 9 below.

Ēₚ_{_{—}}ₜₕᵣₑₛₕ^{new}=α_{TG}×(Ēₚ_{_{—}}ₜₕᵣₑₛₕ^{old})+(1−α_{TG})×Ē_{primary}, (Equation 9)

where Ēₚ_{_{—}}ₜₕᵣₑₛₕ represents the primary threshold, and 0<α_{TG}<1. In accordance with one example implementation, α_{TG}=0.99, though the scope of the example embodiments is not limited in this respect.

At step 706, an average TEO energy of a reference signal is calculated. In an example implementation, energy calculator 802 calculates the average TEO energy of the reference signal.

At step 708, a ratio of the average TEO energy of the primary signal to the average TEO energy of the reference signal is calculated. In an example implementation, energy calculator 802 calculates the ratio of the average TEO energy of the primary signal to the average TEO energy of the reference signal.

At step 710, a determination is made whether the ratio is greater than a speech threshold. A speech threshold is a representative magnitude above which a signal is considered to include speech. For example, the ratio being greater than the speech threshold may indicate that the primary signal includes speech. In accordance with this example, the ratio being less than the speech threshold may indicate that the primary signal does not include speech. In an example implementation, comparison module 804 determines whether the ratio is greater than the speech threshold. If the ratio is greater than the speech threshold, flow continues to step 712. Otherwise, flow continues to step 718.

In an example embodiment, second constraint module 800 is configured to update the speech threshold to take into consideration a first proportion of the ratio if the ratio is less than a leakage threshold and to take into consideration a second proportion of the ratio if the ratio is greater than the leakage threshold. The second proportion is different from the first proportion.

For example, the speech threshold may be updated in accordance with Equations 10 and 11 below if the ratio is less than the leakage threshold.

Ēₛ_{_{—}}ₜₕᵣₑₛₕ^{new}=α×(Ēₛ_{_{—}}ₜₕᵣₑₛₕ^{old})+(1−α)×R_{TEO} (Equation 10)

Ēₛ_{_{—}}ₜₕᵣₑₛₕ=ρ×Ēₛ_{_{—}}ₜₕᵣₑₛₕ^{new} (Equation 11)

where Ēₛ_{_{—}}ₜₕᵣₑₛₕ represents the speech threshold, 0<α<1, and 0<ρ<1. In accordance with one example implementation, α=0.6 and ρ=1.25, though the scope of the example embodiments is not limited in this respect.

In accordance with this example, the speech threshold may be updated in accordance with Equations 12 and 13 below if the ratio is greater than the leakage threshold.

Ēₛ_{_{—}}ₜₕᵣₑₛₕ^{new}=β×(Ēₛ_{_{—}}ₜₕᵣₑₛₕ^{old})+(1−β)×R_{TEO} (Equation 12)

Ēₛ_{_{—}}ₜₕᵣₑₛₕ=ρ×Ēₛ_{_{—}}ₜₕᵣₑₛₕ^{new} (Equation 13)

where 0<β<1. In accordance with one example implementation, β=0.999, though the scope of the example embodiments is not limited in this respect.

At step 712, a maximum correlation is determined between the primary signal and instances of the reference signal that correspond to respective time instances that include a time instance to which the primary signal corresponds. In an example implementation, correlation module 806 determines the maximum correlation between the primary signal and the instances of the reference signal. An example technique to determine a maximum correlation between a primary signal and instances of a reference signal is described below with reference to FIG. 9. For instance, the maximum correlation between the primary signal and the reference signal may be relatively high if the primary signal includes a speech component that leaks onto the reference signal.

At step 714, a determination is made whether the maximum correlation is greater than a correlation threshold. For example, the maximum correlation being greater than the correlation threshold may indicate that the primary signal includes speech. In accordance with this example, the maximum correlation being less than the correlation threshold may indicate that the primary signal does not include speech. In one example embodiment, the correlation threshold is equal to 0.65, though the scope of the example embodiments is not limited in this respect. In an example implementation, comparison module 804 determines whether the maximum correlation is greater than the correlation threshold. If the maximum correlation is greater than the correlation threshold, flow continues to step 716. Otherwise, flow continues to step 718.

At step 716, a speech indicator having a first value is provided to an adaptive noise filter. The first value indicates that filter coefficient(s) of a transfer function of the adaptive noise filter are to be updated. In an example implementation, indicator module 808 provides the speech indicator to the adaptive noise filter. For instance, indicator module 808 may determine that the speech indicator is to have the first value in response to the primary signal including speech.

At step 718, a speech indicator having a second value is provided to an adaptive noise filter. The second value indicates that filter coefficient(s) of a transfer function of the adaptive noise filter are not to be updated. In an example implementation, indicator module 808 provides the speech indicator to the adaptive noise filter. For instance, indicator module 808 may determine that the speech indicator is to have the second value in response to the primary signal not including speech.

In some example embodiments, one or more steps 702, 704, 706, 708, 710, 712, 714, 716, and/or 718 of flowchart 700 may not be performed. Moreover, steps in addition to or in lieu of steps 702, 704, 706, 708, 710, 712, 714, 716, and/or 718 may be performed.

It will be recognized that second constraint module 800 may not include one or more of energy calculator 802, comparison module 804, correlation module 806, and/or indicator module 808. Furthermore, second constraint module 800 may include modules in addition to or in lieu of energy calculator 802, comparison module 804, correlation module 806, and/or indicator module 808. Moreover, server 500 may be implemented as one or more servers.

FIG. 9 depicts an example technique to determine a maximum correlation between a primary signal P(n) and instances 902A-902N of a reference signal R(n) in accordance with an embodiment described herein. As shown in FIG. 9, a first instance 902A of the reference signal R(n) is delayed with respect to the primary signal P(n) by Y frames. The first instance 902A of the reference signal R(n) is compared to the primary signal P(n) to determine a correlation therebetween. A second instance 902B is incremented by one frame with respect to the first instance 902A of the reference signal R(n). Accordingly, the second instance 902B of the reference signal R(n) is delayed with respect to the primary signal P(n) by Y-1 frames. The second instance 902B of the reference signal R(n) is compared to the primary signal P(n) to determine a correlation therebetween. Each successive instances of the reference signal R(n) is incremented by an additional frame with respect to the primary signal P(n) and compared to the primary signal P(n) to determine a respective correlation between that instance and the primary signal P(n).

The correlations that correspond to the respective instances 902A-902N of the reference signal R(n) are compared to determine the maximum correlation between the primary signal and the instances 902A-902N. For instance, the maximum correlation may be compared to a correlation threshold to determine whether filter coefficient(s) of a transfer function of an adaptive noise filter are to be updated, as described above in step 714 of flowchart 700.

Example Matlab® code for implementing the example technique described with reference to FIG. 9 is provided below.

function [z] = max_corr(P(fstart:fend), R(fstart:fend))

cnt = 0;
for k = SL:1:SR

cnt = cnt + 1;
nstart = fstart + k;
nend = fend + k;
R_buff = R(nstart:nend);
norm_corr(cnt) = P′*R_buff/(norm(P)*norm(R_buff));

end
[Corr_max, position] = max(norm_corr);

return;

In this example code, fstart denotes the start of the current frame, and fend denotes the end of the current frame. SL and SR determine the length of a sliding window through which the reference signal R(n) is incremented. In an example embodiment, SL=−8, and SR=8. However, these example values are provided for illustrative purposes and are not intended to be limiting. It will be recognized that SL and SR may be any suitable values.

The technique depicted in FIG. 9 is merely one example technique to determine a maximum correlation between a primary signal and instances of a reference signal. The technique described with reference to FIG. 9 is not intended to be limiting. It will be recognized that any suitable technique may be used to determine a maximum correlation between a primary signal and instances of a reference signal.

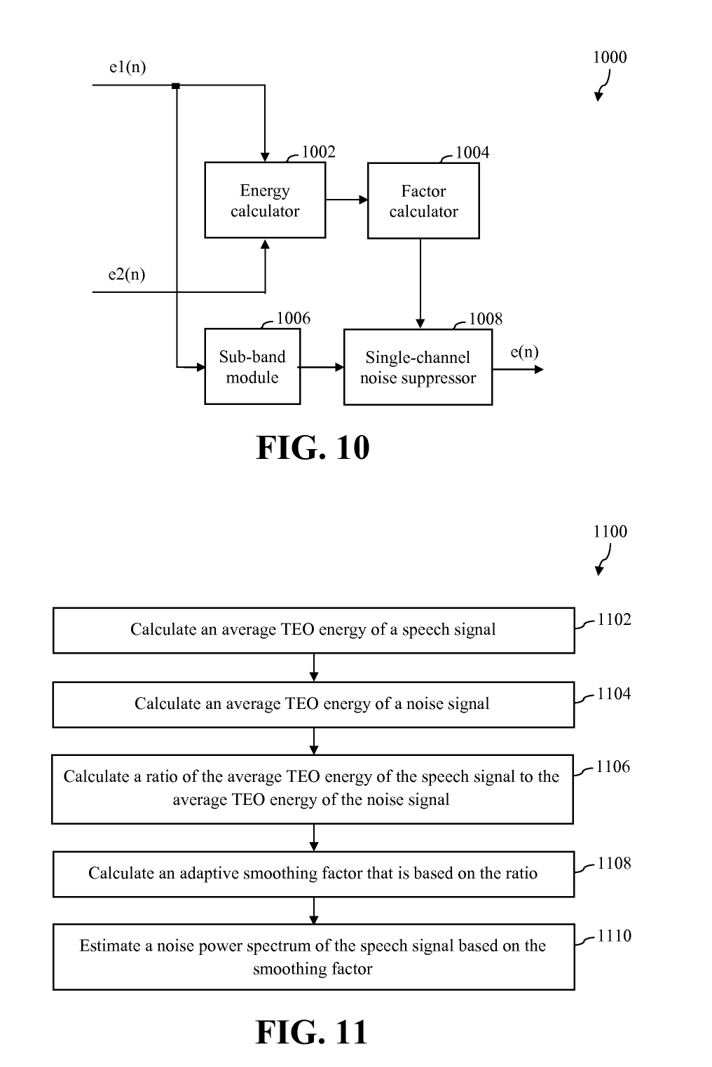

FIG. 10 is a block diagram of an example multi-channel post processor 1000 in accordance with an embodiment described herein. For example, multi-channel post processor 1000 may be coupled to an output of an asymmetric crosstalk resistant adaptive noise canceller (ACTRANC), such as ACTRANC 304 of FIG. 3, though the scope of the example embodiments is not limited in this respect. Generally speaking, multi-channel post processor 1000 operates to suppress noise that is associated with a speech signal e1(n) based on a noise signal e2(n) to provide an output signal e(n). Further detail regarding techniques for suppressing noise that is associated with a speech signal is provided in the following discussion.

As shown in FIG. 10, multi-channel post processor 1000 includes an energy calculator 1002, a factor calculator 1004, a sub-band module 1006, and a single-channel noise suppressor 1008. Example functionality of the elements of multi-channel post processor 1000 will now be described in reference to flowchart 1100 of FIG. 11, which depicts an example method for suppressing noise in accordance with an embodiment described herein. It will be recognized, however, that the functionality of the elements of multi-channel post processor 1000 is not limited to the method depicted by flowchart 1100. Moreover, the method is not limited to the implementation of multi-channel post processor 1000 shown in FIG. 10.

As shown in FIG. 11, the method of flowchart 1100 begins at step 1102. In step 1102, an average Teager energy operator (TEO) energy of a speech signal is calculated. For example, using Equation 1, the average TEO energy of the speech signal may be represented by the equation:

$${\overline{E}}_{speech} = \frac{1}{N} {\sum }_{i = 1}^{N} [ e {1}^{2} ( n ) - e 1 ( n + 1 ) e 1 ( n - 1 ) ] , \qquad ( Equation 14 )$$

where e1(n) represents the speech signal, and N represents the number of samples of the speech signal e1(n). In an example embodiment, the sampling rate is eight kilohertz (kHz), though the scope of the example embodiments is not limited in this respect. The sampling rate may be any suitable rate. In an example implementation, energy calculator 1002 calculates the average TEO energy of the speech signal.

At step 1104, an average TEO energy of a noise signal is calculated. For example, using Equation 1, the average TEO energy of the noise signal may be represented by the equation:

$${\overline{E}}_{noise} = \frac{1}{N} {\sum }_{i = 1}^{N} [ e {2}^{2} ( n ) - e 2 ( n + 1 ) e 2 ( n - 1 ) ] , \qquad ( Equation 15 )$$

where e2(n) represents the noise signal, and N represents the number of samples of the noise signal e2(n). In an example implementation, energy calculator 1002 calculates the average TEO energy of the noise signal.

At step 1106, a ratio of the average TEO energy of the speech signal to the average TEO energy of the noise signal is calculated. For example, the ratio of the average TEO energy of the speech signal to the average TEO energy of the noise signal may be represented by the equation:

$${R}_{TEO\_POST} = \frac{{\overline{E}}_{speech}}{{\overline{E}}_{noise}} , \qquad ( Equation 16 )$$

In an example implementation, energy calculator 1002 calculates the ratio of the average TEO energy of the speech signal to the average TEO energy of the noise signal.

At step 1108, an adaptive smoothing factor that is based on the ratio is calculated. In an example implementation, factor calculator 1004 calculates the adaptive smoothing factor.

At step 1110, a noise power spectrum of the speech signal is estimated based on the smoothing factor. In an example implementation, single-channel noise suppressor 1008 estimates the noise power spectrum of the speech signal.

Sub-band module 1006 is configured to divide the speech signal into a plurality of sub-bands. For instance, each sub-band may correspond to a respective frame of the speech signal. Any one or more of the sub-bands may include speech. Speech may be absent from any one or more of the sub-bands. In accordance with an example embodiment, single-channel noise suppressor 1008 is configured to determine a plurality of noise power estimates that corresponds to the plurality of respective sub-bands based on the smoothing factor. In further accordance with this example embodiment, single-channel noise suppressor 1008 is configured to combine the plurality of noise power estimates to estimate the noise power spectrum of the speech signal. It will be recognized that factor calculator 1004 may calculate the smoothing factor in full-band or in sub-bands. For instance, the smoothing factor may include a plurality of sub-factors that corresponds to the plurality of sub-bands. In accordance with another example embodiment, multi-channel post processor 1000 does not include sub-band module 1006.

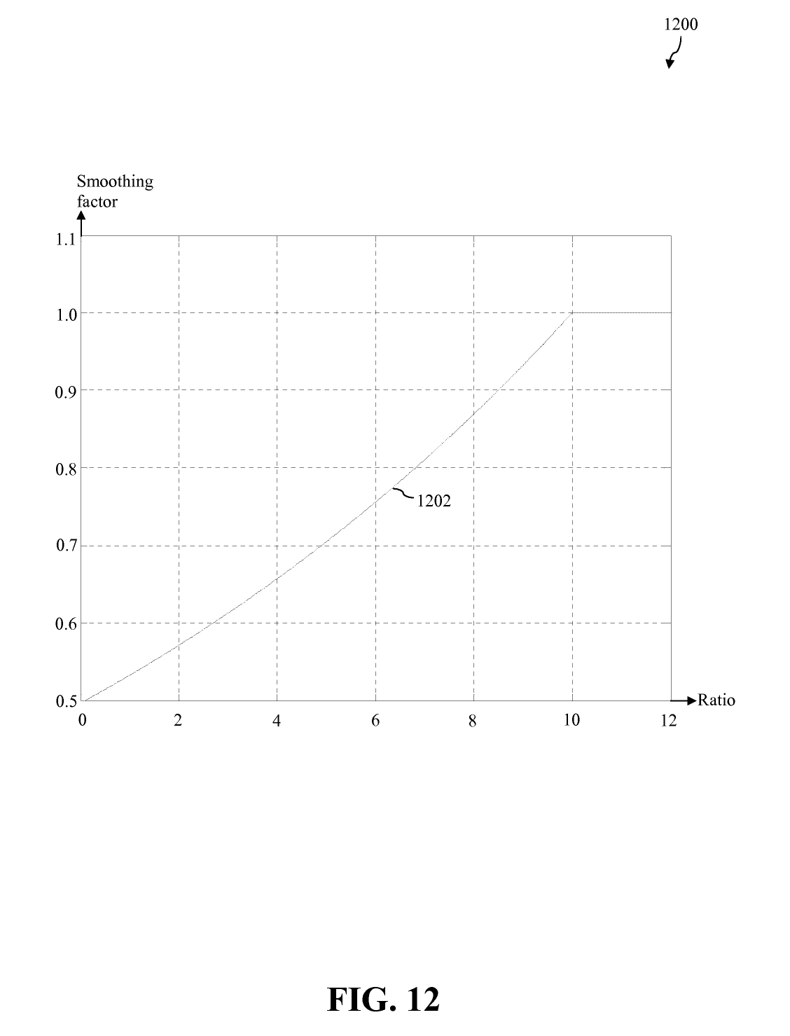

FIG. 12 depicts a graphical representation 1200 of an example relationship between a smoothing factor and a ratio of a speech signal to a noise signal in accordance with an embodiment described herein. The Y-axis of graphical representation 1200 represents the smoothing factor. The X-axis of graphical representation 1200 represents the ratio of the speech signal to the noise signal. Curve 1202 is an example plot of the smoothing factor with reference to the ratio.

As shown in FIG. 12, the smoothing factor is approximately one-half if the ratio is less than or equal to zero. The smoothing factor is approximately one if the ratio is greater than or equal to ten. The smoothing factor is exponentially related to the ratio if the ratio is greater than zero and less than 10. Example Matlab® code for defining the relationship between the smoothing factor and the ratio of the speech signal to the noise signal as shown in FIG. 12 is provided below.

function [z] = curve(R_{TEO})

if R_{TEO} < noise_thres

z = lower_thres;

elseif R_{TEO} > speech_thres

z = upper_thres;

else

z = alpha*exp(beta* R_{TEO});

end

return;

In this example code, function [z] represents curve 1202. In an example embodiment, noise_thres=0.1, speech_thres=10, lower_thres=0.5, upper_thres=0.9999, alpha=0.4966, and beta=0.07. However, these example values are provided for illustrative purposes and are not intended to be limiting. It will be recognized that noise_thres, speech_thres, lower_thres, upper_thres, alpha, and beta may be any suitable values. For instance the values may depend on an extent of leakage of the speech signal onto the noise signal. Moreover, curve 1202 is provided for illustrative purposes and is not intended to be limiting. It will be recognized that the smoothing factor may be related to the ratio of the speech signal to the noise signal in any suitable manner. For instance, the smoothing factor may be linearly related to the ratio with respect to a range of values of the ratio.

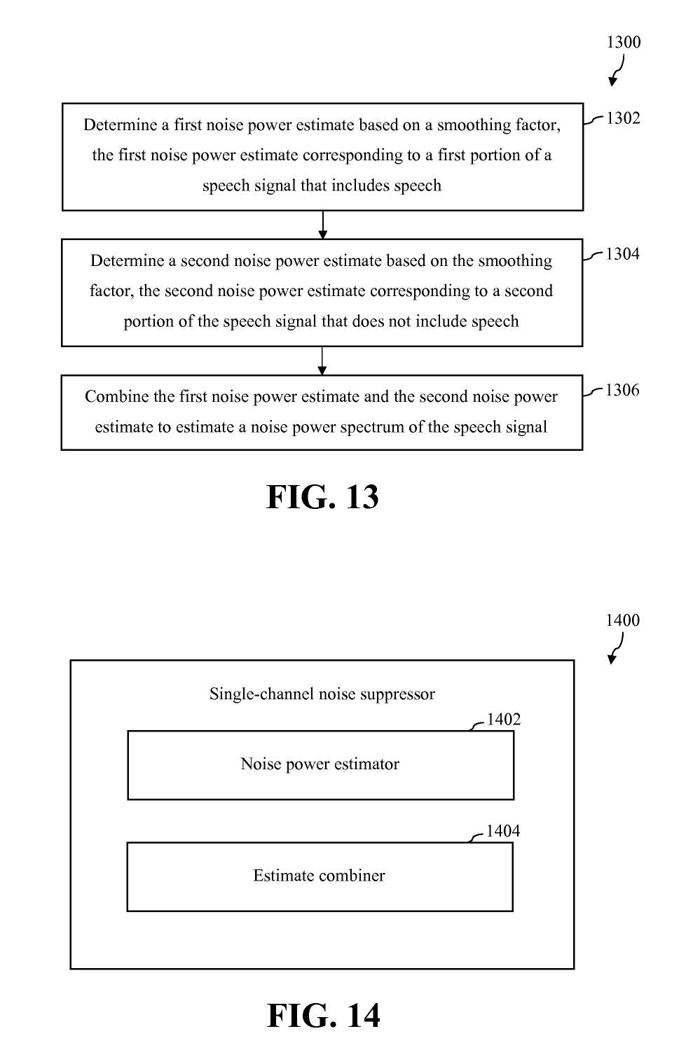

FIG. 13 depicts a flowchart 1300 of still another example method for suppressing noise in accordance with an embodiment described herein. Flowchart 1300 may be performed by single-channel noise suppressor 1008 of multi-channel post processor 1000 shown in FIG. 10, for example. For illustrative purposes, flowchart 1300 is described with respect to a single-channel noise suppressor 1400 shown in FIG. 14, which is an example of a single-channel noise suppressor 1008, according to an embodiment. As shown in FIG. 14, single-channel noise suppressor 1400 includes a noise power estimator 1402 and an estimate combiner 1404. Further structural and operational embodiments will be apparent to persons skilled in the relevant art(s) based on the discussion regarding flowchart 1300.

As shown in FIG. 13, the method of flowchart 1300 begins at step 1302. In step 1302, a first noise power estimate is determined based on a smoothing factor. The first noise power estimate corresponds to a first portion of a speech signal that includes speech. In an example implementation, noise power estimator 1402 determines the first noise power estimate.

At step 1304, a second noise power estimate is determined based on the smoothing factor. The second noise power estimate corresponds to a second portion of the speech signal that does not include speech. In an example implementation, noise power estimator 1402 determines the second noise power estimate.

At step 1306, the first noise power estimate and the second noise power estimate are combined to estimate a noise power spectrum of the speech signal. In an example implementation, estimate combiner 1404 combines the first noise power estimate and the second noise power estimate to estimate the noise power spectrum of the speech signal.

The noise power spectrum of a speech signal may be estimated using a ratio of an average Teager energy operator (TEO) energy of the speech signal to an average TEO energy of a noise signal in any of a variety of ways. In accordance with one example technique for estimating the noise power spectrum, let x(n) and d(n) denote a speech signal and an uncorrelated additive noise signal, respectively, where n is a discrete-time index. The observed noisy signal y(n) is defined as the sum of the speech and uncorrelated additive noise signals. Accordingly, y(n) may be represented by the equation:

y(n)=x(n)+d(n). (Equation 17)

The observed noisy signal y(n) is divided into overlapping frames by the application of a window function and analyzed using a short-time Fourier transfer (STFT) in accordance with the following equation:

$$Y ( k , 1 ) = {\sum }_{n = 0}^{N - 1} y ( n + 1 M ) h ( n ) {e}^{- j ( 2 π / N ) nk} . \qquad ( Equation 18 )$$

In Equation 18, k is a frequency bin index that indicates a designated sub-band of the observed noisy signal y(n); 1 is a time frame index that indicates a designated frame of the observed noisy signal y(n); h is an analysis window of size N; and M is a frame update step in time. Two hypotheses, H₀(k,l) and H₁(k,l), respectively indicate speech absence (i.e., VAD==0) and speech presence (i.e., VAD=1) in the lth frame of the kth sub-band of the observed noisy signal y(n). These hypotheses may be defined in accordance with Equations 19 and 20.

H₀(k,l):Y(k,l)=D(k,l) (Equation 19)

H₁(k,l):Y(k,l)=X(k,l)+D(k,l) (Equation 20)

In Equations 19 and 20, X(k,l) and D(k,l) represent the STFTs of the respective clean and noise signals. The variance of the noise in the kth sub-band may be denoted as:

λ_{d}(k,l)=E[|D(k,l)|²], Equation 21)

where E[|D(k,l)|²] represents the expectation (i.e., estimate) of the energy of the noise signal.

One technique that may be used to estimate the noise power spectrum of the input signal is to apply temporal recursive smoothing to the noisy measurement during periods of speech absence. Such a technique may be described using Equations 22 and 23.

H₀′(k,l):\hat{λ}_{d}(k,l+1)=α_{d}\hat{λ}_{d}(k,l)+(1−α_{d})|Y(k,l)|² (Equation 22)

H₁′(k,l):\hat{λ}_{d}(k,l+1)=\hat{λ}_{d}(k,l) (Equation 23)

In Equations 22 and 23, α_{d} is a fixed smoothing parameter, 0<α_{d}<1, and

H₀′ and H₁′ designate hypothetical speech absence and presence, respectively. A distinction may be made between the hypotheses defined in Equations 19 and 20, which are used for estimating the clean speech, and the hypotheses defined in Equations 22 and 23, which control the adaptation of the noise spectrum. For instance, the fixed smoothing parameter α_{d} of Equations 22 and 23 may be replaced with an adaptive smoothing factor f(R_{TEO}_{_{—}}_{POST}, 1) that is based on the ratio of the average TEO energy of the speech signal to the average TEO energy of the noise signal. Accordingly, Equations 22 and 23 may be rewritten as a single equation that applies to both hypotheses H₀′(k,l) and H₁′(k,l) as follows:

\hat{λ}_{d}(k,l+1)=f(R_{TEO}_{_{—}}_{POST},1)\hat{λ}_{\}(k,l)+(1−f(R_{TEO}_{_{—}}_{POST},1))|Y(k,l)|², (Equation 24)

where the adaptive smoothing factor f(R_{TEO}_{_{—}}_{POST},1) may be computed using the Matlab® code described above with reference to FIG. 12.

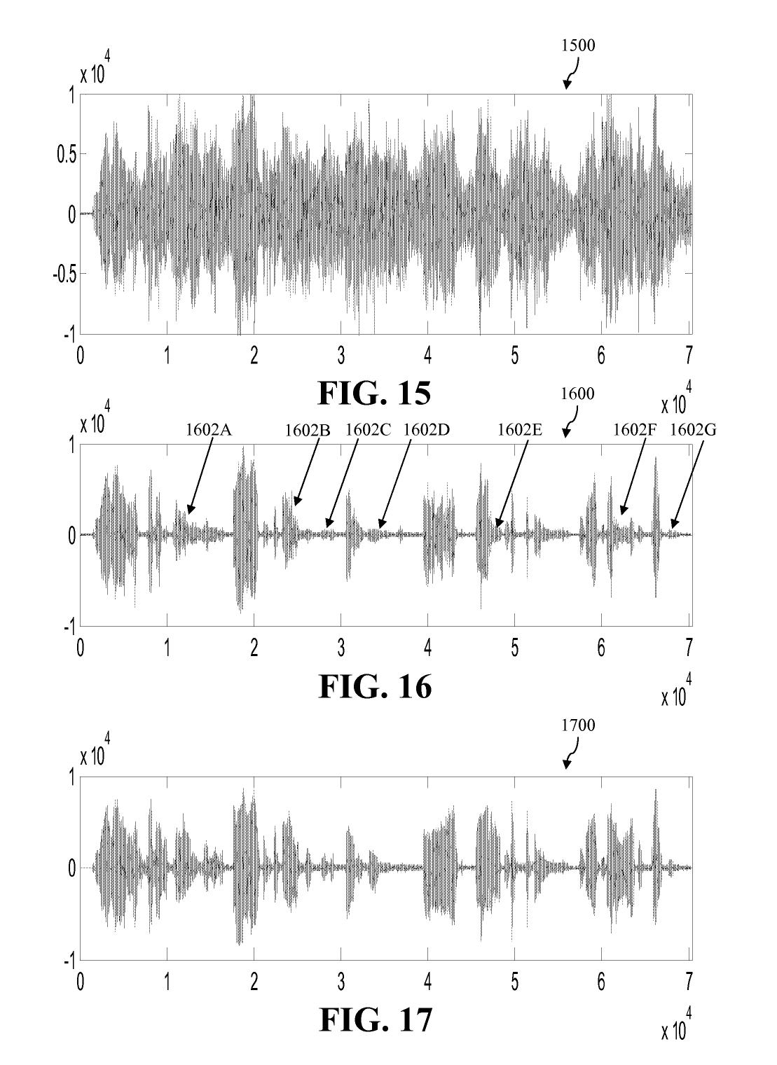

FIG. 15 depicts a graphical representation 1500 of an example noisy input signal y(n) that is unfiltered. The input signal y(n) shown in FIG. 15 includes a speech signal x(n) and an uncorrelated additive noise signal d(n) that may interfere with accurate detection of the speech signal x(n). Accordingly, it may be desirable to filter the input signal y(n) to suppress its uncorrelated additive noise signal d(n).

FIG. 16 depicts a graphical representation of an example input signal y(n) shown in FIG. 15 that has been filtered using a noise suppression technique in accordance with Equations 22 and 23, which are provided above. As shown in FIG. 16, a substantial portion of the noise signal d(n) has been removed from the input signal y(n). However, filtering the input signal y(n) using Equations 22 and 23 provides instances of distortion, as indicated by respective arrows 1602A-1602G.

FIG. 17 depicts a graphical representation of an example input signal y(n) shown in FIG. 15 that has been filtered using a noise suppression technique in accordance with Equation 24. It should be noted that the filtered input signal shown in FIG. 17 does not include the distortion that is seen in the filtered input signal of FIG. 16.

The example noise suppression techniques described herein may be employed with respect to any suitable noise suppression application, including but not limited to beam forming, adaptive noise cancellation, blind source separation (BSS), etc.

It will be recognized that a wireless communication device (e.g., wireless communication device 102) may include multi-channel noise suppression system 300, including any one or more of primary sensor 302A, reference sensor 302B, ACTRANC 304, first constrain module 306A, second constraint module 306B, delay module 308, adaptive speech filter 310A, adaptive noise filter 310B, combiner 312A, combiner 312B, first filter module 314A, second filter module 314B, energy calculator 602, comparison module 604, indicator module 606, energy calculator 802, comparison module 804, correlation module 806, and/or indicator module 808; and/or multi-channel post processor 1000, including any one or more of energy calculator 1002, factor calculator 1004, sub-band module 1006, single-channel noise suppressor 1008, noise power estimator 1402, and/or estimate combiner 1404. However, the embodiments described herein are not limited to wireless communication devices. For instance, any one or more of the aforementioned elements may be included in a non-wireless communication device.

It will be further recognized that ACTRANC 304, first constrain module 306A, second constraint module 306B, delay module 308, adaptive speech filter 310A, adaptive noise filter 310B, combiner 312A, combiner 312B, first filter module 314A, and second filter module 314B depicted in FIG. 3; energy calculator 602, comparison module 604, and indicator module 606 depicted in FIG. 6; energy calculator 802, comparison module 804, correlation module 806, and indicator module 808 depicted in FIG. 8; energy calculator 1002, factor calculator 1004, sub-band module 1006, and single-channel noise suppressor 1008 depicted in FIG. 10; and noise power estimator 1402 and estimate combiner 1404 depicted in FIG. 14 may be implemented in hardware, software, firmware, or any combination thereof.

For example, ACTRANC 304, first constrain module 306A, second constraint module 306B, delay module 308, adaptive speech filter 310A, adaptive noise filter 310B, combiner 312A, combiner 312B, first filter module 314A, second filter module 314B, energy calculator 602, comparison module 604, indicator module 606, energy calculator 802, comparison module 804, correlation module 806, indicator module 808, energy calculator 1002, factor calculator 1004, sub-band module 1006, single-channel noise suppressor 1008, noise power estimator 1402, and/or estimate combiner 1404 may be implemented as computer program code configured to be executed in one or more processors.

In another example, ACTRANC 304, first constrain module 306A, second constraint module 306B, delay module 308, adaptive speech filter 310A, adaptive noise filter 310B, combiner 312A, combiner 312B, first filter module 314A, second filter module 314B, energy calculator 602, comparison module 604, indicator module 606, energy calculator 802, comparison module 804, correlation module 806, indicator module 808, energy calculator 1002, factor calculator 1004, sub-band module 1006, single-channel noise suppressor 1008, noise power estimator 1402, and/or estimate combiner 1404 may be implemented as hardware logic/electrical circuitry.

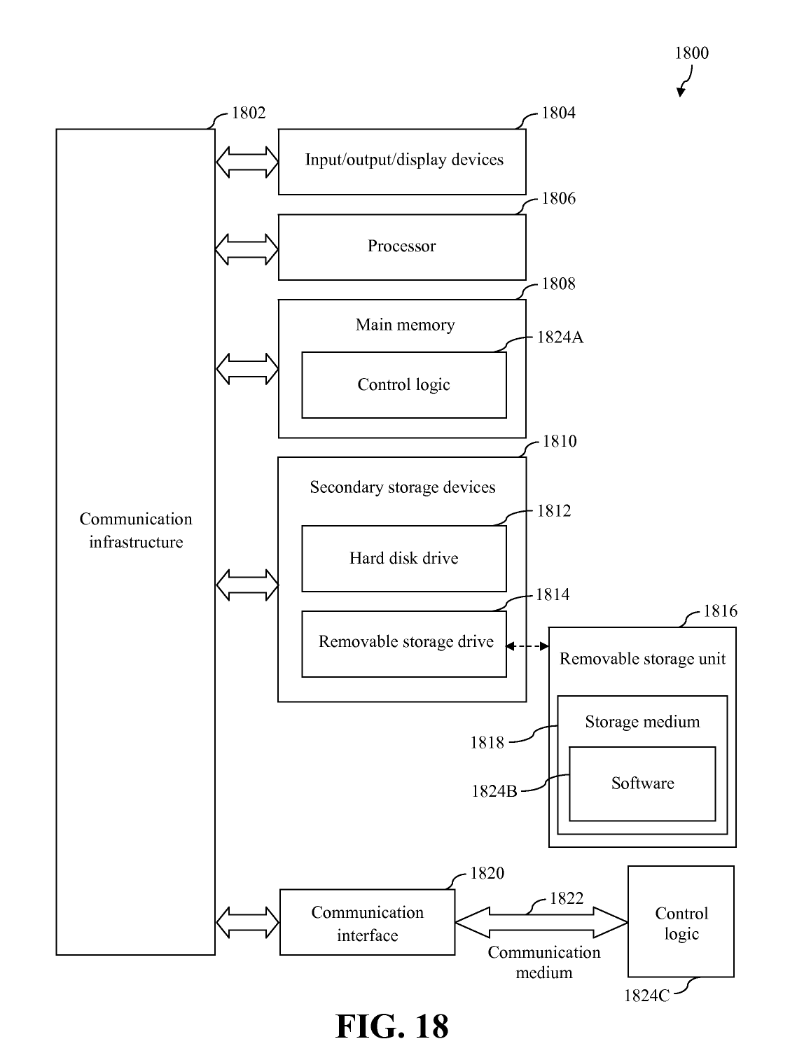

For instance, FIG. 18 is a block diagram of a computer 1800 in which embodiments may be implemented. As shown in FIG. 18, computer 1800 includes one or more processors (e.g., central processing units (CPUs)), such as processor 1806. Processor 1806 may include ACTRANC 304, first constrain module 306A, second constraint module 306B, delay module 308, adaptive speech filter 310A, adaptive noise filter 310B, combiner 312A, combiner 312B, first filter module 314A, and/or second filter module 314B of FIG. 3; energy calculator 602, comparison module 604, and/or indicator module 606 of FIG. 6; energy calculator 802, comparison module 804, correlation module 806, and/or indicator module 808 of FIG. 8; energy calculator 1002, factor calculator 1004, sub-band module 1006, and/or single-channel noise suppressor 1008 of FIG. 10; noise power estimator 1402 and/or estimate combiner 1404 of FIG. 14; or any portion or combination thereof, for example, though the scope of the example embodiments is not limited in this respect. Processor 1806 is connected to a communication infrastructure 1802, such as a communication bus. In some example embodiments, processor 1806 can simultaneously operate multiple computing threads.

Computer 1800 also includes a primary or main memory 1808, such as a random access memory (RAM). Main memory has stored therein control logic 1824A (computer software), and data.

Computer 1800 also includes one or more secondary storage devices 1810. Secondary storage devices 1810 include, for example, a hard disk drive 1812 and/or a removable storage device or drive 1814, as well as other types of storage devices, such as memory cards and memory sticks. For instance, computer 1800 may include an industry standard interface, such as a universal serial bus (USB) interface for interfacing with devices such as a memory stick. Removable storage drive 1814 represents a floppy disk drive, a magnetic tape drive, a compact disk drive, an optical storage device, tape backup, etc.

Removable storage drive 1814 interacts with a removable storage unit 1816. Removable storage unit 1816 includes a computer useable or readable storage medium 1818 having stored therein computer software 1824B (control logic) and/or data. Removable storage unit 1816 represents a floppy disk, magnetic tape, compact disc (CD), digital versatile disc (DVD), Blue-ray disc, optical storage disk, memory stick, memory card, or any other computer data storage device. Removable storage drive 1814 reads from and/or writes to removable storage unit 1816 in a well known manner.

Computer 1800 also includes input/output/display devices 1804, such as monitors, keyboards, pointing devices, etc. For instance, input/output/display devices 1804 may include a primary sensor (e.g., primary sensor 302A) and/or a reference sensor (e.g., reference sensor 302B).

Computer 1800 further includes a communication or network interface 1820. Communication interface 1820 enables computer 1800 to communicate with remote devices. For example, communication interface 1820 allows computer 1800 to communicate over communication networks or mediums 1822 (representing a form of a computer useable or readable medium), such as local area networks (LANs), wide area networks (WANs), the Internet, cellular networks, etc. Network interface 1820 may interface with remote sites or networks via wired or wireless connections.

Control logic 1824C may be transmitted to and from computer 1800 via the communication medium 1822.

Any apparatus or manufacture comprising a computer useable or readable medium having control logic (software) stored therein is referred to herein as a computer program product or program storage device. This includes, but is not limited to, computer 1800, main memory 1808, secondary storage devices 1810, and removable storage unit 1816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, micro-electromechanical systems-based (MEMS-based) storage devices, nanotechnology-based storage devices, as well as other media such as flash memory cards, digital video discs, RAM devices, ROM devices, and the like.

Such computer-readable storage media may store program modules that include computer program logic for ACTRANC 304, first constrain module 306A, second constraint module 306B, delay module 308, adaptive speech filter 310A, adaptive noise filter 310B, combiner 312A, combiner 312B, first filter module 314A, second filter module 314B, energy calculator 602, comparison module 604, indicator module 606, energy calculator 802, comparison module 804, correlation module 806, indicator module 808, energy calculator 1002, factor calculator 1004, sub-band module 1006, single-channel noise suppressor 1008, noise power estimator 1402, and/or estimate combiner 1404; flowchart 400 (including any one or more steps of flowchart 400), flowchart 500 (including any one or more steps of flowchart 500), flowchart 700 (including any one or more steps of flowchart 700), flowchart 1100 (including any one or more steps of flowchart 1100), and/or flowchart 1300 (including any one or more steps of flowchart 1300); and/or further embodiments described herein. Some example embodiments are directed to computer program products comprising such logic (e.g., in the form of program code or software) stored on any computer useable medium. Such program code, when executed in one or more processors, causes a device to operate as described herein.

The invention can be put into practice using software, firmware, and/or hardware implementations other than those described herein. Any software, firmware, and hardware implementations suitable for performing the functions described herein can be used.

### III. Conclusion

While various embodiments have been described above, it should be understood that they have been presented by way of example only, and not limitation. It will be understood by those skilled in the relevant art(s) that various changes in form and details may be made to the embodiments described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
an energy calculator configured to calculate an average Teager energy operator energy of a speech signal and an average Teager energy operator energy of a noise signal, the energy calculator further configured to calculate a ratio of the average Teager energy operator energy of the speech signal to the average Teager energy operator energy of the noise signal;
a factor calculator configured to calculate an adaptive smoothing factor that is based on the ratio; and
a single-channel noise suppressor configured to estimate a noise power spectrum of the speech signal based on the smoothing factor.

2. The system of claim 1, wherein the factor calculator is configured to calculate the adaptive smoothing factor to be equal to a first designated value in response to the ratio being less than a noise threshold;
wherein the factor calculator is configured to calculate the adaptive smoothing factor to be equal to a second designated value in response to the ratio being greater than a speech threshold that is greater than the noise threshold; and
wherein the factor calculator is configured to calculate the adaptive smoothing factor to be equal to a third value that is exponentially related to the ratio in response to the ratio being greater than the noise threshold and less than the speech threshold.

3. The system of claim 2, wherein the first designated value is approximately one-half and the second designated value is approximately one; and
wherein the third value is in a range from approximately one-half to approximately one.

4. The system of claim 1, wherein the single-channel noise suppressor is configured to determine a first noise power estimate based on the smoothing factor, the first noise power estimate corresponding to a first portion of the speech signal that includes speech;
wherein the single-channel noise suppressor is configured to determine a second noise power estimate based on the smoothing factor, the second noise power estimate corresponding to a second portion of the speech signal that does not include speech; and
wherein the single-channel noise suppressor is configured to combine the first noise power estimate and the second noise power estimate to estimate the noise power spectrum of the speech signal.

5. The system of claim 1, further comprising:
a sub-band module configured to divide the speech signal into a plurality of sub-bands;
wherein the single-channel noise suppressor is configured to determine a plurality of noise power estimates that correspond to the plurality of respective sub-bands based on the smoothing factor; and
wherein the single-channel noise suppressor is configured to combine the plurality of noise power estimates to estimate the noise power spectrum of the speech signal.

6. The system of claim 1, further comprising:
an asymmetric crosstalk resistant adaptive noise canceller configured to filter a primary signal based on the noise signal to provide the speech signal, the asymmetric crosstalk resistant adaptive noise canceller further configured to filter a reference signal based on the speech signal to provide the noise signal.

7. The system of claim 6, wherein the asymmetric crosstalk resistant adaptive noise canceller comprises:
a first constraint module configured to determine a value of a first speech indicator to indicate whether the primary signal includes speech according to a first determination technique;
a second constraint module configured to determine a value of a second speech indicator to indicate whether the primary signal includes speech according to a second determination technique that is different from the first determination technique;
an adaptive speech filter configured to filter the primary signal based on the first speech indicator and the noise signal to provide the speech signal; and
an adaptive noise filter configured to filter the reference signal based on the second speech indicator and the speech signal to provide the noise signal.

8. The system of claim 7, wherein at least one of the first constraint module or the second constraint module is configured to utilize a ratio of an average Teager energy operator energy of the primary signal to an average Teager energy operator energy of the reference signal to determine a respective at least one of the first speech indicator or the second speech indicator

9. The system of claim 8, wherein the first constraint module is configured to determine the value of the first speech indicator to indicate that the primary signal does not include speech in response to the ratio of the average Teager energy operator energy of the primary signal to the average Teager energy operator energy of the reference signal being less than a noise threshold; and
wherein the first constraint module is configured to determine the value of the first speech indicator to indicate that the primary signal includes speech in response to the ratio of the average Teager energy operator energy of the primary signal to the average Teager energy operator energy of the reference signal being greater than the noise threshold.

10. The system of claim 9, wherein the first constraint module is further configured to update the noise threshold to take into consideration a first proportion of the ratio of the average Teager energy operator energy of the primary signal to the average Teager energy operator energy of the reference signal in response to the ratio of the average Teager energy operator energy of the primary signal to the average Teager energy operator energy of the reference signal being less than a leakage threshold; and
wherein the first constraint module is further configured to update the noise threshold to take into consideration a second proportion of the ratio of the average Teager energy operator energy of the primary signal to the average Teager energy operator energy of the reference signal that is different from the first proportion in response to the ratio of the average Teager energy operator energy of the primary signal to the average Teager energy operator energy of the reference signal being greater than the leakage threshold.

11. The system of claim 8, wherein the second constraint module is configured to determine the value of the second speech indicator to indicate that the primary signal does not include speech in response to the average Teager energy operator energy of the primary signal being less than a primary threshold; and
wherein the second constraint module is configured to determine the value of the second speech indicator to indicate that the primary signal includes speech in response to the average Teager energy operator energy of the primary signal being greater than the primary threshold.

12. The system of claim 11, wherein the second constraint module is further configured to update the primary threshold to take into consideration the average Teager energy operator energy of the primary signal.

13. The system of claim 8, wherein the second constraint module is configured to determine the value of the second speech indicator to indicate that the primary signal does not include speech in response to the ratio of the average Teager energy operator energy of the primary signal to the average Teager energy operator energy of the reference signal being less than a speech threshold; and
wherein the second constraint module is configured to determine the value of the second speech indicator to indicate that the primary signal includes speech in response to the ratio of the average Teager energy operator energy of the primary signal to the average Teager energy operator energy of the reference signal being greater than the speech threshold.

14. The system of claim 13, wherein the second constraint module is further configured to update the speech threshold to take into consideration a first proportion of the ratio of the average Teager energy operator energy of the primary signal to the average Teager energy operator energy of the reference signal in response to the ratio of the average Teager energy operator energy of the primary signal to the average Teager energy operator energy of the reference signal being less than a leakage threshold; and
wherein the second constraint module is further configured to update the speech threshold to take into consideration a second proportion of the ratio of the average Teager energy operator energy of the primary signal to the average Teager energy operator energy of the reference signal that is different from the first proportion in response to the ratio of the average Teager energy operator energy of the primary signal to the average Teager energy operator energy of the reference signal being greater than the leakage threshold.

15. The system of claim 8, wherein the second constraint module is configured to determine a maximum correlation between the primary signal and instances of the reference signal that correspond to respective time instances that include a time instance to which the primary signal corresponds;
wherein the second constraint module is configured to compare the maximum correlation and a correlation threshold;
wherein the second constraint module is configured to determine the value of the second speech indicator to indicate that the primary signal does not include speech in response to the maximum correlation being less than the correlation threshold; and
wherein the second constraint module is configured to determine the value of the second speech indicator to indicate that the primary signal includes speech in response to the maximum correlation being greater than the correlation threshold.

16. The system of claim 8, wherein the second constraint module is configured to determine a maximum correlation between the primary signal and instances of the reference signal that correspond to respective time instances that include a time instance to which the primary signal corresponds;
wherein the second constraint module is configured to compare the maximum correlation and a correlation threshold;
wherein the second constraint module is configured to determine the value of the second speech indicator to indicate that the primary signal does not include speech in response to the average Teager energy operator energy of the primary signal being less than a primary threshold, further in response to the ratio of the average Teager energy operator energy of the primary signal to the average Teager energy operator energy of the reference signal being less than a speech threshold, and further in response to the maximum correlation being less than the correlation threshold; and
wherein the second constraint module is configured to determine the value of the second speech indicator to indicate that the primary signal includes speech in response to the average Teager energy operator energy of the primary signal being greater than the primary threshold, further in response to the ratio of the average Teager energy operator energy of the primary signal to the average Teager energy operator energy of the reference signal being greater than the speech threshold, and further in response to the maximum correlation being greater than the correlation threshold.

17. The system of claim 7, wherein the adaptive speech filter is configured to update a filter coefficient of a transfer function of the adaptive speech filter if and only if the value of the first speech indicator indicates that the primary signal does not include speech; and
wherein the adaptive noise filter is configured to update a filter coefficient of a transfer function of the adaptive noise filter if and only if the value of the second speech indicator indicates that the primary signal includes speech.

18. The system of claim 17, wherein the adaptive speech filter is configured to use a normalized least mean square technique to update the filter coefficient of the transfer function of the adaptive speech filter; and
wherein the adaptive noise filter is configured to use a normalized least mean square technique to update the filter coefficient of the transfer function of the adaptive noise filter.

19. A method comprising:
calculating an average Teager energy operator energy of a speech signal;
calculating an average Teager energy operator energy of a noise signal;
calculating a ratio of the average Teager energy operator energy of the speech signal to the average Teager energy operator energy of the noise signal;
calculating an adaptive smoothing factor that is based on the ratio; and
estimating a noise power spectrum of the speech signal based on the smoothing factor.

20. The method of claim 19, wherein calculating the adaptive smoothing factor comprises:
calculating the adaptive smoothing factor to be equal to a first designated value if the ratio is less than a noise threshold;
calculating the adaptive smoothing factor to be equal to a second designated value if the ratio is greater than a speech threshold, the speech threshold being greater than the noise threshold; and
calculating the adaptive smoothing factor to be equal to a third value that is exponentially related to the ratio if the ratio is greater than the noise threshold and less than the speech threshold.

21. The method of claim 20, wherein the first designated value is approximately one-half and the second designated value is approximately one; and
wherein the third value is in a range from approximately one-half to approximately one.

22. The method of claim 19, wherein estimating the noise power spectrum of the speech signal comprises:
determining a first noise power estimate based on the smoothing factor, the first noise power estimate corresponding to a first portion of the speech signal that includes speech;
determining a second noise power estimate based on the smoothing factor, the second noise power estimate corresponding to a second portion of the speech signal that does not include speech; and
combining the first noise power estimate and the second noise power estimate to estimate the noise power spectrum of the speech signal.

23. The method of claim 19, further comprising:
dividing the speech signal into a plurality of sub-bands;
wherein estimating the noise power spectrum of the speech signal comprises:
determining a plurality of noise power estimates that correspond to the plurality of respective sub-bands based on the smoothing factor; and
combining the plurality of noise power estimates to estimate the noise power spectrum of the speech signal.

24. The method of claim 19, further comprising:
filtering a primary signal using an asymmetric crosstalk resistant adaptive noise canceller based on the noise signal to provide the speech signal; and
filtering a reference signal using the asymmetric crosstalk resistant adaptive noise canceller based on the speech signal to provide the noise signal.

25. The method of claim 24, further comprising:
determining a value of a first speech indicator to indicate whether the primary signal includes speech using a first determination technique; and
determining a value of a second speech indicator to indicate whether the primary signal includes speech using a second determination technique that is different from the first determination technique, at least one of the first determination technique or the second determination technique utilizing a ratio of an average Teager energy operator energy of the primary signal to an average Teager energy operator energy of the reference signal;
wherein filtering the primary signal comprises:
filtering the primary signal using the asymmetric crosstalk resistant adaptive noise canceller based on the first speech indicator and the noise signal to provide the speech signal; and
wherein filtering the reference signal comprises:
filtering the reference signal using the asymmetric crosstalk resistant adaptive noise canceller based on the second speech indicator and the speech signal to provide the noise signal.

26. A system comprising:
a delay module coupled between a primary input node and an intermediate node, the delay module configured to delay a primary signal that is received at the primary input node with respect to a reference signal;
a first constraint module coupled between the intermediate node and a reference input node, the first constraint module configured to provide a first speech indicator having a first value in response to a ratio of an average Teager energy operator energy of the primary signal to an average Teager energy operator energy of a reference signal that is received at the reference input node being less than a noise threshold, the first constraint module configured to provide the first speech indicator having a second value in response to the ratio being greater than the noise threshold;
a second constraint module coupled to the intermediate node, the second constraint module configured to provide a second speech indicator having a third value or a fourth value depending on the average Teager energy operator energy of the primary signal;
an adaptive speech filter coupled between the intermediate node and a primary output node, the adaptive speech filter configured to filter the primary signal based on a noise signal to provide a speech signal in accordance with a first transfer function, the adaptive speech filter further configured to update a coefficient of the first transfer function in response to the first speech indicator having the first value, the adaptive speech filter further configured to not update the coefficient of the first transfer function in response to the first speech indicator having the second value;
an adaptive noise filter coupled between the reference input node and a reference output node, the adaptive noise filter configured to filter the reference signal based on the speech signal to provide the noise signal in accordance with a second transfer function, the adaptive noise filter further configured to update a coefficient of the second transfer function in response to the second speech indicator having the third value, the adaptive noise filter further configured to not update the coefficient of the second transfer function in response to the second speech indicator having the fourth value;
an energy calculator coupled between the primary output node and the reference output node, the energy calculator configured to calculate an average Teager energy operator energy of the speech signal and an average Teager energy operator energy of the noise signal, the energy calculator further configured to calculate a ratio of the average Teager energy operator energy of the speech signal to the average Teager energy operator energy of the noise signal;
a factor calculator configured to calculate an adaptive smoothing factor based on the ratio of the average Teager energy operator energy of the speech signal to the average Teager energy operator energy of the noise signal; and
a single-channel noise suppressor configured to estimate a noise power spectrum of the speech signal based on the adaptive smoothing factor.

27. The system of claim 26, further comprising:
a sub-band module configured to divide the speech signal into a plurality of sub-bands;
wherein the single-channel noise suppressor is configured to determine a plurality of noise power estimates that correspond to the plurality of respective sub-bands based on the smoothing factor; and
wherein the single-channel noise suppressor is configured to combine the plurality of noise power estimates to estimate the noise power spectrum of the speech signal.
